(19) United States
(12) Patent Application Publication
(10) Pub. No.: US 2016/0037521 A1
(43) Pub. Date: Feb. 4, 2016

(54) WIRELESS COMMUNICATION DEVICE

(71) Applicant: KABUSHIKI KAISHA TOSHIBA, Tokyo (JP)

(72) Inventor: Hideyuki NAKA, Yokohama Kanagawa (JP)

(21) Appl. No.: 14/635,977

(22) Filed: Mar. 2, 2015

(30) Foreign Application Priority Data
Aug. 4, 2014 (JP) 2014-158952

(51) Int. Cl. H04W 72/04; H04W 4/00; H04L 5/00; H04B 15/00

(52) U.S. Cl. CPC H04W 72/0453; H04B 15/00; H04W 4/008; H04W 72/0446; H04L 5/0005; H04W 84/12

(57) ABSTRACT

A wireless communication device includes a detection unit, a time interval estimation unit, a setting unit, and a wireless communication unit. The detection unit is configured to detect interfering electric waves in a predetermined frequency band. The time interval estimation unit is configured to estimate a time interval in which communication is to be performed by the wireless communication device. The setting unit is configured to set a communication frame length based on the time interval estimated by the time interval estimation unit. The wireless communication unit is configured to perform communication using the predetermined frequency band, according to the communication frame length that is determined based on the estimated time interval.

### CROSS-REFERENCE TO RELATED APPLICATION

This application is based upon and claims the benefit of priority from Japanese Patent Application No. 2014-158952, filed Aug. 4, 2014, the entire contents of which are incorporated herein by reference.

### FIELD

Embodiments described herein relate generally to a wireless communication device.

### BACKGROUND

Wireless communication is performed using groups of data referred to as frames or packets. When frames are communicated, limited wireless resources are utilized in an efficient manner by using a technology referred to as Time Division Multiple Access (or TDMA).

Further, when frames being transmitted in a wireless LAN collide (i.e., when transmission of the frames occurs simultaneously), a mechanism referred to as carrier sense multiple access/collision avoidance (or CSMA/CA) is used. With CSMA/CA, a sender that detects a collision after transmitting a frame waits a random time before transmitting the frame a second time, where it is unlikely that a second collision of the frame will occur after waiting the random amount of time.

When transmitting frames using CSMA/CA in a wireless LAN, a sender determines an available frequency at which frames are to be transmitted. However, other communication systems that are unrelated to the wireless LAN, but are in proximity to the wireless LAN, may also generate electrical waves on the same frequency being used by the wireless LAN. For example, Bluetooth® devices transmit at a frequency that overlaps with the 2.4 GHz frequency band of the wireless LAN standard. In such a case, communication on the wireless LAN may be degraded even when electrical wave interference (i.e., collision) is prevented by the use of CSMA/CA.

### DESCRIPTION OF THE DRAWINGS

FIG. 1 is a block diagram illustrating a configuration of a wireless communication device according to a first embodiment.

FIGS. 2A to 2C are diagrams illustrating a time interval according to the first embodiment.

FIG. 3 is a diagram illustrating a communication packet length according to the first embodiment.

FIG. 4 is a flowchart illustrating a processing operation of the wireless communication device according to the first embodiment.

### DETAILED DESCRIPTION

Embodiments provide a wireless communication device that improves communication throughput in a communication environment in which electrical wave interference may occur.

In general, according to one embodiment, a wireless communication device includes a detection unit, a time interval estimation unit, a setting unit, and a wireless communication unit. The detection unit is configured to detect interfering electric waves in a predetermined frequency band. The time interval estimation unit is configured to estimate, based on a detection of the detection unit, a time interval in which communication is to be performed by the wireless communication device. The setting unit is configured to set a communication frame length based on the time interval estimated by the time interval estimation unit. The wireless communication unit is configured to perform communication using the predetermined frequency band, according to the communication frame length that is determined based on the estimated time interval.

Hereinafter, embodiments will be described with reference to the drawings.

### First Embodiment

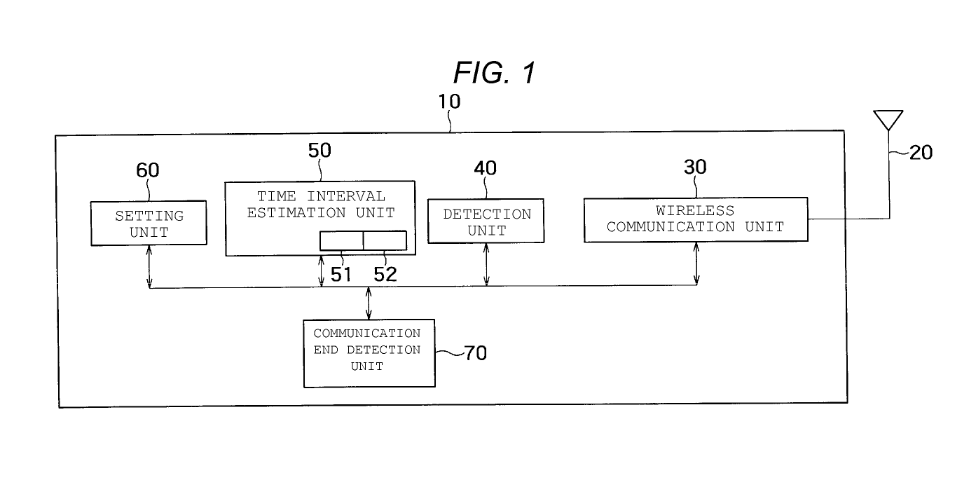

FIG. 1 is a block diagram illustrating a configuration of a wireless communication device 10 according to a first embodiment. The wireless communication device 10 includes an antenna 20, a wireless communication unit 30, a detection unit 40, a time interval estimation unit 50, a setting unit 60, and a communication end detection unit 70, as illustrated in FIG. 1.

Further, the time interval estimation unit 50 includes an average value determination unit 51 and a time interval setting unit 52.

The antenna 20 illustrated in FIG. 1 receives a radio signal and supplies the radio signal to the wireless communication unit 30. Further, the antenna 20 transmits electric waves according to a radio signal received from the wireless communication unit 30.

The wireless communication unit 30 converts the analog radio signal received from the antenna 20 to a digital signal. The wireless communication unit 30 transmits this digital signal to the detection unit 40. Further, the wireless communication unit 30 converts a digital modulation signal that is to be transmitted to an analog signal, and supplies the analog signal to the antenna 20.

More specifically, the wireless communication unit 30 down-converts the analog radio signal received by the antenna 20. Then, the wireless communication unit 30 performs analog-to-digital (A/D) conversion on the down-converted radio signal, and then performs a demodulation process to obtain a digital radio signal. Further, the wireless communication unit 30 performs a predetermined modulation process on transmission data and then performs up-conversion to supply the resulting data signal to the antenna 20 at the time of transmission of data.

The detection unit 40 detects whether there are interfering electrical waves that use the same frequency band as a frequency band in which the wireless communication device 10 performs transmission and reception. Detection unit 40 makes a determination as to whether electrical waves are electrical waves from an intended communication partner, or are interfering electric waves. This determination is made, for example, by analyzing a header portion of a received communication frame. Alternatively, the determination may be made based on a frame length of the received communication frame, a transmission interval, or the like.

The time interval estimation unit 50 estimates a time interval in which uninterrupted communication is possible without being affected by interfering electrical waves (hereinafter referred simply to as a “time interval”). For example, the time interval estimation unit 50 estimates a time interval in which an adjacent wireless communication device does not transmit interfering electrical waves, based on a detection result of the detection unit 40.

More specifically, the average value determination unit in the time interval estimation unit 50 measures, a predetermined number of times, a time interval in which the interfering electrical waves are not generated, and computes an average value of these time intervals.

If an average value newly determined by the average value determination unit 51 differs from a set time interval value set based on a past average value by a predetermined amount or more, the time interval setting unit 52 in the time interval estimation unit 50 updates the set time interval value based on the newly detected average value. If not, the past average value is retained.

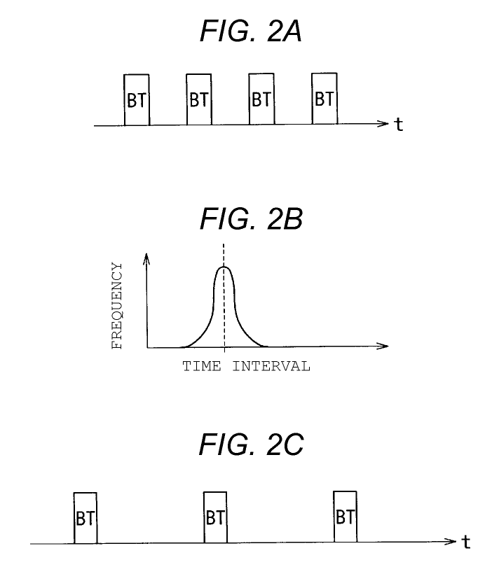

FIGS. 2A to 2C are diagrams illustrating how the time interval estimation unit 50 estimates the time interval. FIG. 2A illustrates, for example, an example in which communication frames of a speaker receiving a sound signal transmitted through Bluetooth® (IEEE802.15.1) become interfering electrical waves. A horizontal axis of FIG. 2A indicates time. In Bluetooth, communication frames having a predetermined time width (frame length) are transmitted at predetermined time intervals, as illustrated. FIG. 2B is a diagram illustrating a distribution of time intervals of the interfering electrical waves of FIG. 2A. A horizontal axis of FIG. 2B indicates the time interval, and a vertical axis indicates a frequency. The time interval of the communication frame is not necessarily constant, but has a characteristic such as normal distribution, as illustrated in FIG. 2B. Thus, if a communication frame length of the wireless communication device 10 is set based on a time interval having a maximum frequency, it is possible to minimize interference with the interfering electrical waves.

Further, a time interval of the interfering electrical waves is not necessarily constant even in the same Bluetooth communication. For example, FIG. 2C illustrates an example in which communication frames of a keyboard transmitting a key operation signal through Bluetooth become interfering electric waves. In the case of the keyboard, the time interval tends to be longer than that of the speaker of FIG. 2A. Thus, even when a wireless scheme of the interfering electrical waves is known in advance to correspond to Bluetooth, a correct time interval is not determined if the time interval of the interfering electrical waves is not actually measured.

Further, for example, when the wireless communication device 10 according to this embodiment performs wireless communication in a wireless LAN using a 2.4 GHz band, which is the same frequency band that Bluetooth uses, interference of electrical waves may occur. Therefore, in this embodiment, the time interval of the interfering electric waves is accurately estimated by the time interval estimation unit 50, and an optimal communication frame length is set by the setting unit 60 so that wireless communication in the wireless LAN is performed using the time interval.

For example, the setting unit 60 sets the communication frame length based on multiplication of the time interval estimated by the time interval estimation unit 50 and a transmission rate in the wireless communication unit 30. In this case, in order to decrease a frequency of electrical wave interference, a coefficient for shortening the time interval may be multiplied by the time interval to obtain a new time interval. Then, the set communication frame length is stored in a storage unit (not illustrated) within the setting unit 60.

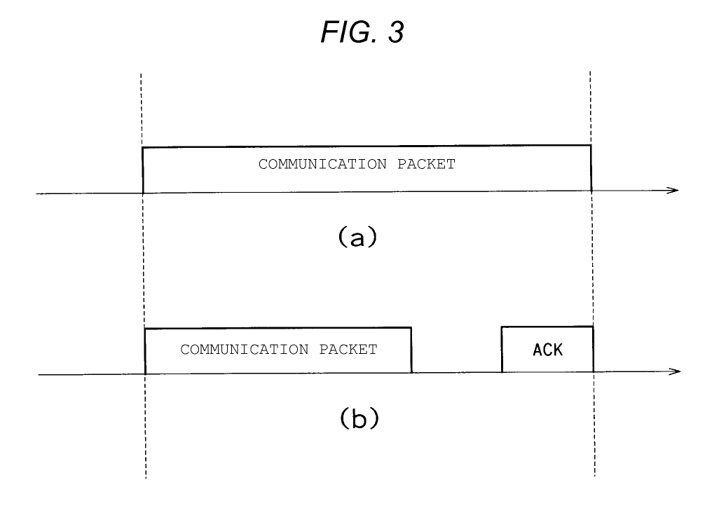

FIG. 3 is a schematic diagram illustrating the communication frame length set by the setting unit 60. In FIG. 3, a horizontal axis indicates time, and an interval between dotted lines indicates a time interval.

Part (a) of FIG. 3 illustrates an example in which the setting unit 60 sets an entire time interval as the communication frame length. In this case, data may be effectively transmitted.

Part (b) of FIG. 3 illustrates an example in which the setting unit 60 sets the communication frame length that takes into account a reception period of a communication acknowledgement signal (for example, a period of time in which ACK or Block ACK is replied). In this case, electrical waves are transmitted at a shorter communication frame length than the time interval estimated by the time interval estimation unit 50, but data transmission to a communication destination within the time interval may be confirmed.

Further, information necessary for transmission of a header or the like may be included in the communication frame length. For example, a MAC header is included in the communication frame length according to IEEE802.11a, b, or g/.

The communication end detection unit 70 detects a time at which communication by the interfering electrical waves ends based on the detection result of the detection unit 40. For example, the communication end detection unit 70 detects a time at which signal power in a band by an adjacent wireless communication device is reduced to less than a predetermined threshold, which indicates non-detection.

In this case, the communication end detection unit 70 detects a time at which an output signal of the detection unit 40 is changed, for example, from a HIGH signal to a LOW signal as the time at which communication of the interfering electrical waves ends.

When the communication end detection unit 70 detects the time at which communication of interfering electrical waves ends, the communication end detection unit 70 transmits a detection result to the wireless communication unit 30. The wireless communication unit 30 starts wireless communication in units according to the communication frame length set by the setting unit 60 based on this detection result.

Thus, in this embodiment, since frames are transmitted according to the time interval in which electrical wave interference from the adjacent wireless communication device does not occur in an electrical wave interference band, influence of the electrical wave interference may be suppressed. Therefore, even when wireless communication devices that are incompatible in preventing electrical wave interference are used in a common area, electrical wave interference between the wireless communication devices may be reduced.

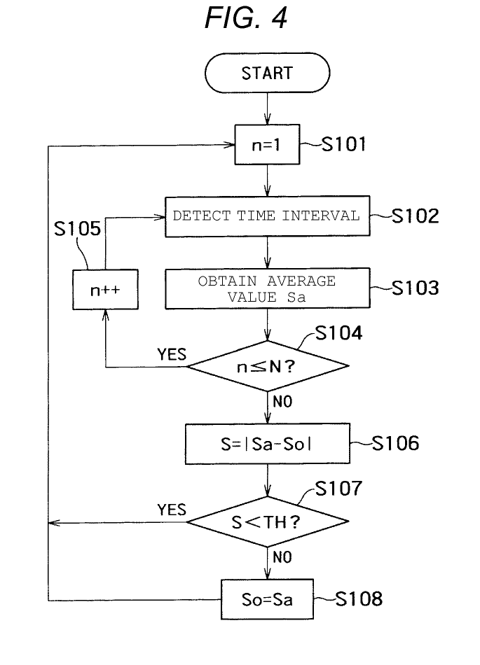

FIG. 4 is a flowchart illustrating a processing operation of the wireless communication device 10, according to the first embodiment. The flowchart illustrates a processing operation in which the communication frame length is set. First, the average value determination unit 51 sets an internal counter n to 1 (step S101). Then, the average value determination unit 51 detects a time interval in which there is no electric wave interference (step S102). Then, the average value determination unit 51 determines an average value of the detected time intervals corresponding to the n times (step S103). Thus, when n=1, the average value obtained in step S103 matches the time interval detected in step S102.

Then, the average value determination unit 51 determines whether a value of the internal counter n exceeds a predetermined maximum number of times N (step S104). If n N, the average value determination unit 51 increases n by 1 (step S105) and repeats the process from step S102.

If it is determined that n>N in step S104, the time interval setting unit 52 sets the average value obtained in step S103 at that time to Sa, and detects a difference S with a previously set time interval value So (step S106). The time interval setting unit 52 determines whether the difference S exceeds a predetermined threshold Th (step S107). If the difference S is equal to or smaller than the predetermined threshold Th, the average value determination unit 51 performs the process from step S101 to perform re-calculation of the average value. If the difference S is greater than the threshold Th, the time interval setting unit 52 updates the set time interval value So with the average value Sa obtained in step S103 (step S108), and performs the process from step S101.

Thus, in the process of FIG. 4, the average value of the time intervals in which the electrical wave interference does not occur is set as the set time interval value So, and when the average value greatly varies, the set time interval value So is updated in accordance with the varying average value. Further, the value of N used for the determination in step S105 may be varied.

The setting unit 60 sets a new communication frame length based on the set time interval value So obtained in the process of FIG. 4.

Thus, in the process of FIG. 4, since the time interval in which the electrical wave interference does not occur is continuously detected and the set time interval value So is updated, it is possible to precisely set the communication frame length according to the timer interval in which electrical wave interference does not occur.

When the communication end detection unit 70 detects a time at which interfering electrical waves are no longer present, the wireless communication unit 30 starts wireless communication using the communication frame length set by the setting unit 60.

Thus, in the first embodiment, since the communication frame length is set based on the average value of the time intervals in which the interfering electrical waves are not generated, wireless communication may be performed without causing electrical wave interference even in the presence of other wireless communication devices generating interfering electrical waves. Accordingly, it is possible to prevent degradation of communication throughput caused by the electrical wave interference. Further, even when the time interval in which interfering electrical waves are not generated varies, the variation may be rapidly detected and the communication frame length may be updated, and thus, the communication frame length appropriate for a wireless LAN may be set and the influence of the electrical wave interference may be avoided.

### Second Embodiment

In the above-described embodiment, the communication frame length is set without consideration of a communication profile of the interfering electrical waves. However, when the communication profile of the interfering electrical waves is determined in advance, interference of the electrical waves is prevented by setting the communication frame length in consideration of the determined communication profile, and degradation of the communication throughput may be prevented.

More specifically, in the case of Bluetooth, the interfering electrical waves have a plurality of communication profiles, and the communication frame length or a time interval between the communication frames is different for each communication profile. The communication profile of the interfering electric waves may be determined, for example, from header information of the communication frame.

Thus, when the communication profile is determined in advance, the time interval setting unit 52 changes the set time interval value So to a value corresponding to the communication profile in the flow in FIG. 4.

In this case, since the time interval between communication frames varies near the set time interval value So, the time interval setting unit 52 sets the value of N in step S105 to a small value with respect to a normal process. Accordingly, the time required for the time interval estimation unit 50 to estimate the time interval may be shortened.

Thus, the setting unit 60 sets the communication frame length based on the communication profile of the interfering electric waves and the time interval estimated by the time interval estimation unit 50. Accordingly, in the second embodiment, since the communication frame length is set in consideration of the communication profile of the interfering electrical waves, the interference of the electrical waves may be suppressed, the setting time for the communication frame length may be shortened, and the communication throughput may be further improved in comparison with the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication device comprising:
a detection unit configured to detect interfering electrical waves in a predetermined frequency band;
a time interval estimation unit configured to estimate, based on a detection of the detection unit, a time interval in which communication is to be performed by the wireless communication device;
a setting unit configured to set a communication frame length based on the time interval estimated by the time interval estimation unit; and
a wireless communication unit configured to perform communication using the predetermined frequency band, according to the communication frame length that is determined based on the estimated time interval.

2. The device according to claim 1, further comprising:
a communication end detection unit configured to detect a time at which communication of the interfering electrical waves ends,
wherein the wireless communication unit performs communication according to the communication frame length after the detected time.

3. The device according to claim 2, wherein the communication end detection unit is configured to detect a time at which a signal power of the interfering electrical waves is less than a predetermined threshold.

4. The device according to claim 1,
wherein the time interval estimation unit is configured to estimate the time interval in which communication is to be performed by the wireless communication device based on a repeated measurement result.

5. The device according to claim 4,
wherein the time interval estimation unit includes:
an average value determination unit configured to measure predetermined number of time intervals in which the interfering electrical waves are not generated, and compute an average value of the time intervals; and
a time interval setting unit configured to update a set time interval value based on an average value newly determined by the average value detection unit when a difference between the set time interval value and the newly determined average value exceeds a predetermined value.

6. The device according to claim 5, wherein the average value determination unit is configured to retain the set time interval value when the difference between the set time interval value and the newly detected average value is equal to or less than the predetermined value.

7. The device according to claim 6, wherein the setting unit is configured to set the communication frame length based on the set time interval value.

8. The device according to claim 1,
wherein the setting unit is configured to set the communication frame length based on a communication profile of the interfering electrical waves and on the time interval estimated by the time interval estimation unit.

9. The device according to claim 1, further comprising an antenna configured to receive a radio signal, and to supply the radio signal to the wireless communication unit.

10. The device according to claim 1, wherein the interfering electrical waves are generated by a second wireless device that is adjacent to the wireless communication device.

11. The device according to claim 10, wherein the interfering electrical waves are generated by a Bluetooth device.

12. A method of transmitting frames by a first wireless communication device, the first wireless communication device being located adjacent to a second wireless communication device, the method comprising:
determining a first value that represents the length of a time interval in which no electrical waves interfering with communication by the first wireless communication device are transmitted by the second wireless communication device;
determining a frame length of a plurality of frames based on the first value; and
transmitting, by the first wireless communication device, the plurality of frames in accordance with the frame length.

13. The method according to claim 12, wherein determining the first value comprises:
detecting a plurality of time intervals in which the second wireless communication device does not transmit electrical waves; and
computing an average length of the plurality of time intervals as the first value.

14. The method according to claim 13, wherein the average length is computed based on a predetermined number of time intervals.

15. The method according to claim 13, further comprising:
determining whether the first value differs from a second value by a predetermined amount, the second value representing a previously determined representation of a length of a time interval in which no electrical waves interfering with communication by the first wireless communication device are transmitted by the second wireless communication device; and
responsive to the determining, setting the frame length of the plurality of frames in accordance with the first value.

16. The method according to claim 12, wherein the second wireless communication device is configured to transmit Bluetooth frames.

17. The method according to claim 12, further comprising:
determining a communication profile of electrical waves transmitted by the second wireless communication device; and
setting the frame length of the plurality of frames in accordance with the communication profile.

18. A wireless communication device, comprising:
a detection unit configured to detect time intervals in which an adjacent wireless communication device does not transmit a signal that interferes with frames transmitted by the wireless communication device;
a time interval estimation unit configured to determine a first value that represents the length of the time intervals; and
a setting unit configured to set a frame length of frames transmitted by the wireless communication device in accordance with the first value.

19. The device according to claim 18, further comprising:
a communication end detection unit configured to detect a time at which the adjacent wireless communication device stops transmitting the interfering signal.

20. The device according to claim 19, further comprising:
a wireless communication unit configured to receive a detection result from the communication end detection unit and, responsive to the detection result, transmit frames in accordance with the frame length.
